(19) United States
(12) Patent Application Publication
(10) Pub. No.: US 2013/0064958 A1
(43) Pub. Date: Mar. 14, 2013

(54) Expansion Of Extruded Cereals With Good Source Of Fiber

(71) Applicant: The Quaker Oats Company, Chicago, IL (US)

(72) Inventors: Robert Chatel, Hoffman Estates, IL (US); Justin French, Fox River Grove, IL (US); Sandy Mui, Cary, IL (US)

(73) Assignee: The Quaker Oats Company, Chicago, IL (US)

(21) Appl. No.: 13/656,776

(22) Filed: Oct. 22, 2012

Related U.S. Application Data
(62) Division of application No. 12/262,855, filed on Oct. 31, 2008, now abandoned.

(51) Int. Cl. A23L 1/18

(52) U.S. Cl. 426/625; 426/449

(57) ABSTRACT

A cereal composition comprising a waxy starch in an amount from about 5 to about 15% by weight of the total composition and a cereal mixture comprising a fiber source in an amount from about 1 to about 15% by weight of the total composition. The cereal composition is mixed with water and expanded by extrusion to form a high-fiber cereal product. Also, a method of producing a high fiber expanded cereal product comprising the step of combining a waxy starch in an amount from about 5 to about 15% by weight of the total composition and a cereal mixture comprising a fiber source in an amount from about 1 to about 15% by weight of the total composition to form a total cereal composition. The total cereal composition is mixed with water and extruded to form an expanded cereal product.

### RELATED APPLICATION

This application is a divisional application of U.S. Ser. No. 12/262,855, filed Oct. 31, 2008, pending, entitled Expansion of Extruded Cereals with Good Source of Fiber, and hereby incorporated by reference in its entirety.

### FIELD OF INVENTION

The present invention relates generally to high fiber extruded cereals. In particular, the invention relates to expansion of a high fiber cereal product.

### BACKGROUND OF THE INVENTION

There is a demand for foods that contain a high level of total dietary fiber, e.g., for colon health, reducing cholesterol, improving blood sugar control, and lowering risk of heart disease. It would be convenient to have a ready to eat expanded breakfast cereal that includes a good source of dietary fiber.

For many years cereal products have been produced from grains in expanded form. Expanded cereals have a unique crispness and texture and can be produced by many methods, including extrusion. However, extruded whole grain cereals with significant amounts of dietary fiber are difficult to expand without overcooking Typically, the incorporation of high levels of fiber into extruded cereal products depresses product expansion.

Methods are needed to produce an expanded cereal product with a good source of dietary fiber.

### SUMMARY OF THE INVENTION

In one aspect, a total cereal composition is provided. The cereal composition comprises a waxy starch in an amount from about 5 to about 15% by weight of the total cereal composition and a cereal mixture comprising a fiber source, wherein the fiber source is in an amount from about 1 to about 15% by weight of the total cereal composition. The total cereal composition is mixed with water to form a cereal dough which expands upon extrusion.

Another aspect relates to a method of producing an expanded cereal product. The method comprises combining a waxy starch in an amount from about 5 to about 15% by weight of the total cereal composition and a cereal mixture comprising a fiber source, wherein the fiber source is in an amount from about 1 to about 15% by weight of the total cereal composition to form a cereal dough when mixed with water. The cereal dough is extruded to form an expanded cereal.

### DETAILED DESCRIPTION OF THE INVENTION

The present invention is directed to achieving expansion in extruded cereals having a good source of fiber. The inventors have discovered that expansion of a high fiber cereal product can be achieved by adding waxy starch in a quantity from about 5 to about 15% by weight of the total cereal composition to a cereal mixture comprising a fiber source in a quantity from about 1 to about 15% by weight of the total cereal composition to create a total cereal composition. In one embodiment, waxy starch may be added in an amount from about 7 to about 10% by weight of the total cereal composition to a cereal mixture comprising a fiber source in a quantity from about 6 to about 10% by weight of the total cereal composition. The total cereal composition is mixed with water to form a cereal dough which is extruded to form an expanded cereal. The expanded cereal product has a bland base flavor and is a good source of fiber.

According to one embodiment of the present invention, a total cereal composition is provided. A cereal mixture comprises cereal flour, sugar, and a fiber source. The cereal mixture is combined with a waxy starch to form a total cereal composition.

The terms “by weight of the total cereal composition” or “weight % of the total cereal composition” as used herein means the combined weight of all the dry ingredients exclusive of water and prior to entering an extruder. A cereal dough forms after water is added to the total cereal composition or after water and heat are added to the total cereal composition. Heat is commonly added through the extrusion process.

Any suitable fiber source can be used in a cereal mixture of the present invention. For example, corn or oat fiber may be the source of fiber within a cereal mixture. Additionally, any bran source may be used such as bran from cereal grains (e.g., wheat bran, oat bran, corn bran). Whole grain corn or oat flours may also be used. The fiber source may be selected from the group consisting of corn fiber, oat fiber, wheat bran, oat bran, corn bran, whole corn flour, whole oat flour, and blends thereof. In one embodiment, the fiber source is selected from the group consisting of whole oat flour, oat fiber, corn fiber, and blends thereof

In one embodiment, the fiber content is in the range from about 1 to about 15% by weight of the total dry cereal. In another embodiment, the fiber content in the cereal mixture is in the range from about 6 to about 10% by weight of the total dry cereal composition.

The skilled practitioner recognizes that extrusion dies have orifices through which the material is extruded. Thus, extrudate that contains insoluble particulate that will not fit through the orifice will clog the orifices, reducing product quality and production. Thus, the skilled practitioner can take appropriate action to ensure that the insoluble particles are of a size smaller than the smallest orifice.

Non-limiting examples of whole grain cereal flours include whole wheat, whole rice, whole corn (maize), whole millet, whole sorghum (milo), whole rye, whole triticale, whole oats, whole barley, whole teff, whole wild rice, whole spelt, whole buckwheat, whole amaranth, whole quinoa, whole kaniwa, whole cockscomb, other whole grain cereal flours known in the art, and combinations thereof. Typically, the whole grain cereal flour is present in an amount from about 60% to about 90% by weight of the total cereal composition. In one embodiment the grain cereal flour is present in an amount from about 75% to about 85% by weight of the total cereal composition. With the guidance provided herein, the skilled practitioner will be able to prepare the total cereal composition.

The waxy starch can be any suitable waxy starch. A waxy starch is a starch that contains 10% or less of its starch content as amylose. Non-limiting examples of cereal grain sources for waxy starches include rice, corn (maize), sorghum (milo), barley, as well as other varieties of grain or starchy seeds. The waxy starch is selected from the group consisting of corn, rice, barley, and blends thereof. To achieve product expansion during extrusion, the waxy starch is present in the total cereal composition in an amount from about 5% to about 15% by weight. In one embodiment, the waxy starch is present from about 7% to about 10% by weight of the total cereal composition. In one embodiment, waxy corn starch is the waxy starch source.

Other ingredients typically found in a cereal product may also be added to the cereal mixture. With the guidance provided herein, the skilled practitioner will be able to add a variety of ingredients to the cereal mixture. For example, any suitable sugar such as sucrose, fructose, dextrose or others can be incorporated into the cereal mixture. Typically, the sugar is present in an amount less than about 15% by weight, and more typically less than about 10% of the total cereal composition.

Various minor components, such as flavors, colors, salts, and preservatives can be added. For example, any salt commonly used in the art, such as sodium chloride, can be added. Calcium carbonate can also be added for calcium fortification and flavor development. Preservatives such as BHA, BHT, and the like, also are suitably added. In particular, such preservatives often are applied with a carrier. A premix comprising BHT in a maltodextrin carrier is suitably used. A vitamin/mineral supplement also can be added to the cereal mixture to boost the nutritional content of the cereal. Alternatively, a vitamin solution can be sprayed on the surface of the cereal. Furthermore, the resulting cereal pieces exiting the extruder may further comprise a coating such as a sugar coating or other coatings known in the art.

According to another aspect of the present invention, a method of producing an expanded high fiber cereal product is provided. The method comprises combining a waxy starch at a concentration of about 5 to about 15% by weight of the total cereal composition with a cereal mixture comprising cereal flours, a fiber source, and other ingredients to form a total cereal composition.

The total cereal composition is mixed with water to form a wet, free-flowing mixture. The wet, free-flowing mixture then is extruded through a die under conditions sufficient to form a cooked dough. Water may be added to the total cereal composition at a concentration of approximately 16 to about 22% by weight of the combined dry and wet ingredients. Water may be in the form selected from the group consisting of liquid water, steam, and blends thereof.

The skilled practitioner recognizes that the combination of dry ingredients with a suitable amount of water yields a wet, free-flowing mixture. This mixture is uncooked, or raw. A dough is formed when the starches present in the mixture are fully gelatinized. Thus, a cooked dough is formed from the wet, free-flowing mixture by addition of heat. In an embodiment of the invention, heat is added by extrusion. For extrusion purposes, a starch is gelatinized when the starch granules are disrupted, releasing the amylose and amylopectin starch molecules.

Gelatinized starch transforms the wet, free-flowing mixture of solids and water into a dough. This dough has viscoelastic properties that enable the dough to expand as it exits an extruder die, provided the temperature is above the boiling point of water.

Extrusion typically is carried out in an extruder having a barrel having plural barrel sections. The barrel sections may have ratio of length L to diameter D between about 1 and about 10, more typically about 4. Further, the number of barrel sections typically is 1 to about 8, more typically about 5 barrel sections per extruder barrel. Often, these sections can be independently heated or cooled, in accordance with the requirements of the use. With the guidance provided herein, the skilled practitioner will be able to establish the appropriate amount of water and heat to add to (or subtract from) the total cereal composition to form a cooked cereal dough.

The addition of waxy corn starch to a high-fiber cereal mixture results in a lighter, crispier texture, and a longer bowl-life, when expanded by extrusion, as compared to a high-fiber expanded cereal without waxy corn starch. When a high-fiber product not including waxy starch is expanded by extrusion, a significant amount of work is required to expand the extruded product. This additional work increases the water soluble starch in the solid product and consequently reduces bowl life. Thus, an embodiment of the invention using extrusion to heat and expand the product yields a high-fiber expanded product of the invention having better texture and longer bowl life.

Although the inventor prefers not to be limited by theory, it is believed that less stress is desirable during extrusion because it minimizes the starch damage and the associated water solubility. Thus, the high-fiber product of this embodiment of the invention has a longer bowl life than a high-fiber product not containing waxy starch.

In one embodiment of the present invention, the cereal dough is cooked during extrusion in a suitable extruder, as is well known in the art for making expanded puffed cereals. Typically, such extruding is done at low moisture and high shear. The total moisture content of the cereal dough in the extruder is typically in the range between about 16% and about 22% by total weight of the cereal dough. This concentration can be achieved by adding water before extrusion to the dry, free-flowing mixture and mixing with a suitable mixer. Low levels of steam can also be added to the wet, free-flowing mixture. This allows even hydration of the flours, starches, and fiber and preheats the wet mixture prior to extrusion.

To achieve the desired degree of expansion, the cereal extruder can be operated to attain a dough temperature between about 300° F. and about 350° F. As the cereal exits the extruder, the cereal product expands rapidly to produce an expanded cereal with the cereal length being cut or otherwise divided into pieces as is well known in the art. In one embodiment of the present invention, the dough can be formed and cooked during extrusion in a suitable extruder. As the cereal exits the extruder, the cereal pieces expand rapidly to produce expanded cereal. With the guidance provided herein, the skilled practitioner will be able to establish appropriate extrusion conditions.

### EXAMPLE 1

An extruded high fiber cereal product is prepared using ingredients in the ranges of relative proportions set forth in Table 1.

| Base Dry Mix | Approx. wt % |
|---|---|
| Whole White Corn Flour | 75-85 |
| Waxy Starch | 7-11 |
| Oat Flour | 5-9 |
| Sugar and Other Ingredients | 3-9 |
| TOTAL | 100 |

These ingredients are mixed with water in a quantity of between about 6-15 weight percent of the dry ingredients. A low level of steam is added to the wet, free-flowing mixture. The wet, free-flowing mixture is extruded at conditions that will raise the temperature to between about 300 and about 350° F. to form an expanded cereal product. The product has a small cell structure, low bulk density, good texture, and a bland base flavor. The product, which also has better bowl life than an otherwise identical product devoid of waxy starch prepared in the same way, has about 3 g of fiber per serving.

### EXAMPLE 2

An extruded high fiber cereal product was prepared using ingredients in the relative proportions shown in Table 2.

TABLE 2

| Base Dry Mix | Approx. wt % |
|---|---|
| Whole White Corn Flour | 78 |
| Waxy Corn Starch | 9 |
| Oat Flour | 7 |
| Sugar and Other Ingredients | 6 |
| TOTAL | 100 |

The expanded high fiber cereal was prepared by mixing the ingredients shown in Table 1 with water. Water was added in quantity sufficient to equal about 10 wt percent of the weight of the dry ingredients. Low levels of steam also were added to the cereal mixture to evenly hydrate the flours, starches, and fiber and to preheat the wet mixture prior to extrusion. The cereal dough was subsequently cooked and extruded in a cereal extruder to form expanded cereal product. Most of the heat came from the friction generated by the extrusion process. To achieve the desired degree of expansion, the cereal extruder was operated to attain a dough temperature between about 320° F. and about 330° F. The cereal dough created a product having a bland base flavor and approximately 3 g of fiber per serving. The product also had a small cell structure, low bulk density, and a good texture.

Given the benefit of the above disclosure and description of exemplary embodiments, it will be apparent to those skilled in the art that numerous alternative and different embodiments are possible in keeping with the general principles of the invention disclosed here. The above examples are not limiting. For example, waxy starch of any type may be present in the total cereal composition in an amount from less than 9% by weight of the total cereal composition or greater than 9% by weight of the total cereal composition, as described in the specification. Those skilled in this art will recognize that all such various modifications and alternative embodiments are within the true scope and spirit of the invention. The appended claims are intended to cover all such modifications and alternative embodiments.

1. A method of producing a high-fiber expanded cereal product comprising:
forming a cereal composition by combining a waxy starch in an amount from about 5 to about 15% by weight of the total cereal composition, a fiber source in an amount from about 1 to about 15% by weight of the total cereal composition, and whole grain cereal flour in an amount of from about 60 to about 90% by weight of the total cereal composition;
mixing the cereal composition with water in the form selected from the group consisting of liquid water, steam, and blends thereof to form a wet, free-flowing mixture; and
extruding the wet, free-flowing mixture at a temperature between about 300 and about 350° F. and forming the expanded cereal product.

2. The method of claim 1, wherein the fiber source is selected from the group consisting of corn fiber, oat fiber, wheat bran, oat bran, corn bran, corn flour, oat flour, and blends thereof

3. The method of claim 1, wherein the fiber source is selected from the group consisting of oat flour, oat fiber, corn fiber, and blends thereof.

4. The method of claim 1, wherein the waxy starch is selected from the group consisting of waxy corn starch, waxy rice starch, waxy barley starch, and blends thereof.

5. The method of claim 1, wherein the waxy starch is waxy corn starch.

6. The method of claim 1 wherein the water is about 16 to about 22% by weight of the total composition and water.

7. The method of claim 1 wherein the whole grain cereal flour comprises about 75% to about 85% by weight of the total cereal composition.

8. The method of claim 1 wherein the whole grain cereal flour is selected from the group consisting of whole wheat, whole rice, whole corn (maize), whole millet, whole sorghum (milo), whole rye, whole triticale, whole oats, whole barley, whole teff, whole wild rice, whole spelt, whole buckwheat, whole amaranth, whole quinoa, whole kaniwa, whole cockscomb, and combinations thereof.

9. A method of producing an expanded cereal product comprising:
forming a cereal composition by combining a waxy starch in an amount from about 7 to about 10% by weight of the total cereal composition, a fiber source is in an amount from about 6 to about 10% by weight of the total cereal composition, and whole grain cereal flour in an amount of from about 60 to about 90% by weight of the total composition;
mixing the total cereal composition with water in the form of liquid water, steam, and blends thereof, to form a wet, free-flowing mixture; and
extruding the wet, free-flowing mixture to form a cooked cereal dough that expands as it exits the extruder.

10. The method of claim 9, wherein the fiber source is selected from the group consisting of corn fiber, oat fiber, wheat bran, oat bran, corn bran, corn flour, oat flour, and blends thereof.

11. The method of claim 9, wherein the waxy starch is selected from the group consisting of waxy corn starch, waxy rice starch, waxy barley starch, and blends thereof.

12. The method of claim 9, wherein the waxy starch is waxy corn starch.

13. The method of claim 9 wherein the water is about 16 to about 22% by weight of the total composition and water.

14. The method of claim 9 wherein the whole grain cereal flour comprises about 75% to about 85% by weight of the total cereal composition.

15. The method of claim 9 wherein the whole grain cereal flour is selected from the group consisting of whole wheat, whole rice, whole corn (maize), whole millet, whole sorghum (milo), whole rye, whole triticale, whole oats, whole barley, whole teff, whole wild rice, whole spelt, whole buckwheat, whole amaranth, whole quinoa, whole kaniwa, whole cockscomb, and combinations thereof.

16. The method of claim 9 wherein the extruding occurs at a temperature between about 300 and about 350° F.

17. An expanded high fiber cereal product prepared in accordance with the method of claim 1.

18. An expanded high fiber cereal product prepared in accordance with the method of claim 9.
